(19) United States
(12) Patent Application Publication
(10) Pub. No.: US 2025/0369461 A1
(43) Pub. Date: Dec. 4, 2025

(54) SELF-PROPELLED AGRICULTURAL HARVESTER

(71) Applicant: CLAAS Selbstfahrende Erntemaschinen GmbH, Harsewinkel (DE)

(72) Inventors: John Penner, Beelen (DE); Norbert Strieker, Verl (DE); Dennis Lutterbeck, Telgte (DE); Andreas Wilken, Bissendorf (DE); Alexander Bürger, Herzebrock-Clarholz (DE); Stefan Schiewer, Bad Salzuflen (DE); Tobias Deufel, Bielefeld (DE)

(73) Assignee: CLAAS Selbstfahrende Erntemaschinen GmbH, Harsewinkel (DE)

(21) Appl. No.: 19/221,832

(22) Filed: May 29, 2025

(30) Foreign Application Priority Data
May 29, 2024 (DE) 10 2024 115 099.8

(51) Int. Cl. F15B 21/00; A01D 90/10; F15B 13/04; F15B 15/22

(52) U.S. Cl. CPC F15B 21/008; A01D 90/10; F15B 13/0401; F15B 15/22

(57) ABSTRACT

A self-propelled agricultural harvester. A harvester, such as a forage harvester, may comprise a machine frame, a transfer device mounted on the machine frame for transferring processed harvested material to a transport vehicle, and a hydraulic actuator connected to the transfer device. Using the hydraulic actuator, the transfer device may be rotated about a horizontal axis of rotation relative to the machine frame, and thereby a position of an end outlet of the transfer device may be changed. To reduce the vibration of the transfer device, a control and regulating device regulates vibration behavior of the transfer device to dampen vibrations of the transfer device. The control and regulating device determines a manipulated variable for controlling a proportional valve, which is operatively connected to the hydraulic actuator and is designed to adjust a volume flow of hydraulic fluid to the hydraulic actuator, for damping the vibrations of the transfer device.

### CROSS REFERENCE TO RELATED APPLICATION

This application claims priority under 35 U.S.C. § 119 to German Patent Application No. DE 10 2024 115 099.8 filed May 29, 2024, the entire disclosure of which is hereby incorporated by reference herein.

### TECHNICAL FIELD

The present invention relates to a self-propelled agricultural harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A harvester may comprise a self-propelled forage harvester. The self-propelled forage harvester may be used to harvest and chop plants standing in a field and to transfer the harvested material (formed from the chopped plants) to a transport vehicle. This transferring may take place continuously during a harvesting operation of the forage harvester. In this regard, it may be necessary for the harvesting operation that a transport vehicle, which may comprise a trailer having a loading space, to drive alongside or behind the forage harvester, thereby moving along with the forage harvester on the field. For this purpose, the transport vehicle may be pulled by a prime mover (e.g., a tractor) or be designed as self-propelled so the transport vehicle may move independently.

The harvested material may be transferred using a transfer device, which may comprise a “discharge chute”, as is known in the industry. For this purpose, the harvested material may be accelerated and guided along the transfer device until it is ejected at an outlet at the end of the transfer device (which may be referred to in the field as the so-called “chute end”). In order for the harvested material to land in the loading space of the transport vehicle, it may be necessary to coordinate the orientation of the transfer device and the position of the transport vehicle relative to the harvester so that at least substantially all of the harvested material lands in the loading space of the transport vehicle.

The transfer device may be movably mounted on the machine frame of the harvester about a horizontal axis of rotation relative to a machine frame of the harvester so that a height at which the end outlet of the transfer device is located above a given surface may be changed. This may be referred to as “lifting”. For this vertical movement of the transfer device, for example, a lifting cylinder may be used, which may be attached at its one end to the machine frame of the harvester and at its other end to the transfer device. The transfer device may be rotated relative to the machine frame about the axis of rotation by operating the hydraulic cylinder, as a result of which it may lengthen (e.g., piston extends from cylinder) or shortens (e.g., piston retracts into cylinder). If necessary, in addition to the rotatability of the transfer device about the aforementioned horizontal axis of rotation, pivotability about a vertical pivot axis is also possible. The movability of the transfer device may serve to align the end outlet of the transfer device relative to the transport vehicle in the described manner so that the transferred harvested material ends up at least substantially completely in the loading space of the transport vehicle.

The transfer devices may be subject to the problem that, due to their size and their weight as well as their one-sided articulation to the machine frame of the harvester, they tend to start vibrating around the horizontal axis of rotation during harvesting operation of the harvester. These vibrations affect the end outlet, which may move noticeably “up and down” during harvesting operation of the harvester. This may occur as a result of unevenness in the ground over which the harvester travels, which may excite the transfer device (so-called “ground excitation”). As a result of the vibrations of the transfer device, it may be more difficult to “aim” at the given loading space of the given transport vehicle. As a result, there may regularly be a loss of harvested material that does not reach the loading space as desired. There is therefore an interest in minimizing the vibrations of the transfer device.

In order to solve this problem, a system for actively damping vibrations of the transfer device may be found in the German unpublished patent application DE 10 2010 017 459 A1, incorporated by reference herein in its entirety. The system may comprise a sensor configured to detect a cause of vibration acting on the transfer device and an evaluation and control unit. The evaluation and control unit may be configured to actuate an actuator, through which the transfer device may be adjusted in its height, depending on the detected cause of vibration in order to dampen vibrations of the transfer device. In this way, DE 10 2010 017 459 A offers an approach on how the vibration of the transfer device may be dampened.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a longitudinal section through a self-propelled agricultural harvester.

FIG. 2 illustrates a schematic representation of a transfer device of the harvester according to FIG. 1.

FIG. 3 is an illustration of an H-infinity control that is performed on a control and regulation unit of the harvester according to FIG. 1.

FIG. 4 is a representation of an LQI control that is performed on a control and regulation unit of the harvester according to FIG. 1.

FIG. 5 is a schematic representation of a mathematical substitute model of the transfer device of the harvester shown in FIG. 1

### DETAILED DESCRIPTION

As discussed in the background, DE 10 2010 017 459 A offers an approach on how the vibration of the transfer device may be dampened. Despite this disclosure, unwanted vibration of the transfer device about the horizontal axis of rotation may still remain during the harvesting operation of the harvesting machine, such as movement of the end outlet in a vertical direction results. This may, in turn, lead to an undesirable loss of harvested material in the described manner, in which the harvested material does not land in the loading space of the given transport vehicle as desired due to the movement of the outlet at the end.

Thus, in one or some embodiments, a harvester is disclosed that reduces the vibration of the transfer device during harvesting operation of the harvester more in comparison with the prior art.

In one or some embodiments, the harvester may comprise a forage harvester. The harvester may include a machine frame, a transfer device mounted on the machine frame, and at least one hydraulic actuator operatively connected to the transfer device. The transfer device may be configured to transfer processed harvested material onto a transport vehicle. The hydraulic actuator may be configured to rotate the transfer device about a horizontal axis of rotation relative to the machine frame. This movement may be referred to as “lifting”. This may make it possible to change the position of an end outlet of the transfer device, which is located at an end of the transfer device facing away from the machine frame, in a vertical direction relative to the machine frame. Thus, this may make it possible to adjust the height of the end outlet of the transfer device using the hydraulic actuator.

For this purpose, the hydraulic actuator may, for example, be formed by at least one hydraulic cylinder (such as a single hydraulic cylinder). In this embodiment, a first end of the hydraulic actuator may be mounted on the machine frame and a second end of the hydraulic actuator opposite the first end may be mounted on the transfer device. In this way, it may be particularly easy to change a distance between the two ends of the hydraulic actuator via a change of its length (such as by extending and retracting a piston from a cylinder) and thereby to rotate the transfer device relative to the machine frame about the horizontal axis of rotation. As explained above, via this rotation, it may be possible to adjust the height of the end outlet of the transfer device so that the end outlet may be actively adjusted in its position to a given transport vehicle. In other words, the hydraulic actuator may help to “aim” the transfer device so that, in the course of transferring, the harvested material delivered via the transfer device lands as completely as possible in the loading space of the transport vehicle.

The harvester may also comprise a control and regulation device configured to regulate the vibration behavior of the transfer device with the aim of at least partly reducing or damping vibrations of the transfer device. Furthermore, the harvester may comprise a proportional valve operatively connected to the hydraulic actuator, which may be configured to adjust a volume flow of a hydraulic fluid to the hydraulic actuator. In one or some embodiments, the adjustment of the volume flow may be smoothly adjustable. In other words, the proportional valve is configured to adjust a volume flow of hydraulic fluid with which the hydraulic actuator is supplied. The volume flow of the hydraulic fluid may be provided, for example, via a hydraulic pump that is fluidically connected to the proportional valve. In this way, a hydraulic pressure may be continuously applied to the proportional valve, wherein a flow of the hydraulic fluid (e.g., the volume flow) to the hydraulic actuator is released to the hydraulic actuator using the proportional valve. The volume flow may thus depend on how far the proportional valve is open.

The control and regulation device may be configured to determine a manipulated variable to actuate the proportional valve in order to dampen or reduce the vibrations of the transfer device and to accordingly actuate or command the proportional valve according to the manipulated variable. For this purpose, the control and regulation device may comprise a controller, through which to determine the manipulated variable. In this regard, the control may be performed on or by means of the control and regulation device. The control and regulation device may be operatively connected to at least one sensor, such as a plurality of sensors, each of which may record information that flows into the control and regulation device in the form of input variables and may be used by the control and regulation device to determine the manipulated variable.

The harvester may have one or more advantages. In particular, the harvester may enable a particularly flexible and needs-based effect on the transfer device via the proportional valve so that its vibration around the horizontal axis of rotation is reduced or damped. In this way, the transfer device may be kept largely free of unwanted movements, even in the event of unevenness in the ground over which the harvester travels so that the transfer of processed harvested material to the transport vehicle may occur reliably.

Damping the vibrations of the transfer device may also have the advantage that the stress on the material is reduced so that the harvester is less susceptible to breakdowns and maintenance work overall. This is based on the consideration that the vibrations of the transfer device may also lead to high forces acting on the machine frame and the transfer device, and thereby place enormous strain on the mechanical structures.

A further advantage is that the effect of force on the machine frame, which may be caused by the vibrations of the transfer device, is reduced, which may increase the driving comfort for the machine operator of the harvester. Therefore, the forces that typically arise during harvesting operation of the harvester as a result of vibrations of the transfer device may be felt by the machine operator in the driver's cab of the harvester and are generally perceived as unpleasant. This may be counteracted by the reduction of the vibrations.

The proportional valve may also offer the advantage that the control commands of the control and regulation device may be implemented particularly quickly (e.g., with a comparatively high frequency) so that the volume flow of the hydraulic fluid supplied to the hydraulic actuator may be changed quickly and may therefore react at high speed to constantly changing effects during harvesting operation that cause vibration of the transfer device. As previously explained, these effects may be, for example, unevenness in the ground, which may result in the so-called ground excitation of the transfer device. The routing of the processed harvested material along the transfer device may also cause the latter to vibrate. If the proportional valve is smoothly adjustable, the volume flow of the hydraulic fluid may also be precisely adjusted so that the behavior of the hydraulic actuator counteracts the vibration of the transfer device more precisely, such as precisely as possible and, as a result, the vibration behavior may be damped particularly effectively.

In one or some embodiments, the harvester has at least one sensor which is configured to detect information relating to at least one parameter, wherein either at least one state of the transfer device may be indirectly described using the parameter, or the parameter directly describes at least one state of the transfer device. Various states of the transfer device are contemplated. For example, the state of the transfer device may be any one, any combination, or all of: its rotational position with regard to the horizontal axis of rotation relative to the machine frame; its vertical acceleration; or a piston-side pressure of the hydraulic actuator.

If, for example, the sensor is suitable for detecting information relating to an acceleration (such as a vertical acceleration) of the transfer device, this sensor may be arranged or positioned directly on the transfer device, for example at an end of the transfer device facing away from the machine frame. Such a sensor may therefore comprise a sensor configured to detect information indicative of or relating to a parameter that directly describes a state of the transfer device. It is also contemplated that the at least one sensor is formed by a pressure sensor, for example, which is configured to detect information indicative relating to a pressure of the hydraulic fluid at or in the hydraulic actuator, for example a piston-side pressure. Using such a sensor, information relating to a parameter may therefore be detected, through which a state of the transfer device may be indirectly described or may be described, wherein the parameter as such does not directly describe the state of the transfer device itself, but rather the state of the hydraulic actuator. In one or some embodiments, the harvester includes a plurality of sensors, each of which may be suitable for detecting information relating to a parameter, wherein these parameters may be different from one another.

In one or some embodiments, the information detected using the at least one sensor may serve as an input variable for the controller, through which the control of the vibration behavior of the transfer device may be performed on the control and regulation device. Accordingly, it may be particularly advantageous if the at least one sensor is connected to or in communication with the control and regulation device in a data-transmitting manner so that the information may be transmitted to the control and regulation device. This connection may be wireless and/or wired.

In one or some embodiments, the harvester comprises at least one sensor which is configured to detect information relating to acceleration, such as a vertical acceleration, of at least a part of the transfer device, wherein the information may be assigned to or indicative of a location of the transfer device at which the sensor is located on the transfer device. For example, the sensor may comprise an acceleration sensor and/or a gyroscope. In one or some embodiments, the sensor is arranged or positioned at the end outlet of the transfer device so that information regarding the vertical acceleration of the transfer device may be detected at its end outlet using the sensor. This end outlet is also known in the art as the “ejection flap”. Since the harvested material exits the transfer device at the end outlet, information regarding the acceleration at this point in the vertical direction may be of particular interest. If this acceleration is reduced, this may result in a calming of the jet of discharged harvested material. It is contemplated that the harvester has two sensors configured to detect information relating to or indicative of the vertical acceleration of the transfer device, wherein one of these sensors comprises a gyroscope and the other sensor comprises an acceleration sensor. In such a case, both sensors may be arranged or positioned in the area of the end outlet of the transfer device.

Furthermore, such a design of the harvester that comprises at least one sensor that is formed by a position sensor may be advantageous. The position sensor may, for example, be formed by a potentiometer. The position sensor may be configured to detect information relating to or indicative of a position of the transfer device in relation to its horizontal axis of rotation. In this way, it is possible to determine the position in which the transfer device is located relative to the machine frame. In this context, “position” may mean a rotational position of the transfer device in relation to the horizontal axis of rotation.

Furthermore, such an embodiment may be advantageous in which the harvester comprises at least one sensor that comprises a pressure sensor. The pressure sensor may, for example, be configured to detect information relating to or indicative of a pressure of the hydraulic fluid. Accordingly, in one or some embodiments, the hydraulic actuator may comprise a double-acting, hydraulic cylinder with which the pressure sensor is associated. This may make it possible, for example, to detect information relating to or indicative of a piston-side pressure of the hydraulic actuator using the pressure sensor. This information may be particularly useful as an input variable to the control and regulation device (e.g., input to the controller of the control and regulation device). In one or some embodiments, the harvester comprises two sensors which comprise pressure sensors, wherein the hydraulic actuator comprises a double-acting hydraulic cylinder, wherein the one pressure sensor is assigned to a piston-side pressure chamber (e.g., for detecting information relating to or indicative of the piston-side pressure), and the other pressure sensor is assigned to the cylinder-side pressure chamber (for detecting information relating to or indicative of the cylinder-side pressure) of the hydraulic actuator.

The arrangement of further sensors on the harvester is readily contemplated, wherein such sensors may be configured, for example, to detect information relating to or indicative of any one, any combination, or all of:
acceleration of the harvester in the direction of travel;
a position of the transfer device in relation to a vertical pivot axis;
an angular acceleration of the transfer device in relation to the vertical pivot axis; a rod-side pressure of the hydraulic actuator; or
a vertical acceleration of the transfer device at one end facing the machine frame (also referred to as “discharge foot” in the art).

The corresponding information may also be made available to the control and regulation device and used therein as input variables for the performed regulation.

If the harvester has at least one sensor (e.g., sensor(s) configured to detect information relating to or indicative of any one, any combination, or all of vertical acceleration; position sensor; or pressure sensor) according to the above explanation, it may be correspondingly particularly advantageous if the control and regulation device may be operated in such a way that the information detected by the given sensor and transmitted to the control and regulation device serves as input variables for the controller to determine the manipulated variable. In this way, the manipulated variable for controlling the proportional valve may be determined as required so that the control and regulation device may effectively dampen the vibration behavior of the transfer device.

In one or some embodiments, the harvester comprises a plurality of sensors, such as at least one or more of the types of sensors described above, such as any one, any combination, or all of: at least one sensor configured to detect information relating to or indicative of the vertical acceleration of the transfer device; at least one sensor comprising a position sensor; or at least one sensor comprising a pressure sensor. In this embodiment, the control and regulation device is configured to use the information from the sensors together as input variables for the regulation performed on the control and regulation device and therefore to determine the manipulated variable for actuating the proportional valve using these input variables. In this case, the control and regulation device may be operated in such a way that it may actuate the proportional valve corresponding with the determined manipulated variable so that pressure peaks of the hydraulic actuator and acceleration peaks of the transfer device, which may each be caused by ground excitations of the harvester, are compensated. In other words, the control and regulation device may use the information from a plurality of sensors, which in each case may be taken into account as input variables for determining the manipulated variable, wherein the manipulated variable may be determined with the primary objective of damping pressure peaks in the hydraulic actuator and acceleration peaks of the transfer device (such as at its end outlet), if and to the extent that these are caused by ground excitations of the harvester. According to the above explanation, these ground excitations may be caused by unevenness in the ground over which the harvester travels. This type of control of the vibration behavior of the transfer device may be particularly advantageous in order to keep the end outlet of the transfer device noticeably quieter in comparison to the prior art and therefore facilitate the aiming at the loading space of the given transport vehicle.

In one or some embodiments, the control and regulation device is configured to control the vibration behavior according to the principle of H-infinity control. This type of regulation is an extremely robust regulation in which unintentional “breakout” of the manipulated variable is practically impossible. In other words, the regulation in this embodiment is particularly insensitive to model inaccuracies, which may occur in any control system as a matter of principle. Furthermore, the control quality with which the controller implemented on the control and regulation device operates may be particularly high in this embodiment so that the vibration behavior of the transfer device may be damped particularly effectively.

If the regulation of the vibration behavior of the transfer device is performed according to the H-infinity principle, it may be particularly advantageous if the H-infinity regulation is designed according to the principle of “mixed sensitivity loop shaping” (see https://de.mathworks.com/help/robust/gs/using-mixsyn-for-h-infinity-loop-shaping.html). The control and regulation device may be operated in such a way that at least one weighting function, which may be used within the context of the H-infinity control, weights the sensitivity of the actuation of the proportional valve. In this case, the dynamics with which the proportional valve is actuated may be weighted using the weighting function.

In this embodiment, it may also be advantageous if the control and regulation device may be operated in such a way that the manipulated variable with which the proportional valve may be actuated is limited via at least one weighting function used in the context of H-infinity control. The manipulated variable may be a control current with which an actuator of the proportional valve is energized and, as a result, the proportional valve is adjusted.

Furthermore, it may be advantageous if the control and regulation device may be operated in such a way that model uncertainties of a mathematical model of the transfer device are weighted via at least one weighting function used in the H-infinity control. In one or some embodiments, the model uncertainties are formed by deviations of the mathematical model of the transfer device in comparison to the real transfer device.

Using the weighting functions, which may be used in combination, the manipulated variable for actuating the proportional valve may be determined in a particularly robust manner so that the stability of the system is improved or guaranteed. Furthermore, a particularly high control quality may be achieved with this embodiment, which may be reflected in a noticeably lower vibration of the transfer device during harvesting operation of the harvester compared to the prior art.

As an alternative to the embodiment of the control in the form of an H-infinity control, it may also be advantageous if the control and regulation device is configured to control the vibration behavior of the transfer device according to the principle of LQI control (“linear-quadratic-integral control”, also known as an “LQ controller” with an additional integral component or “Riccati controller”). This type of control may also be characterized by its extremely high robustness and high control quality.

If the LQI control principle is used, it may be particularly advantageous if the control system comprises an integrating controller component and a proportional controller component. In this case, the control and regulation device may be operated in such a way that the manipulated variable is determined jointly by the two controller components. The integrating controller component may serve for stationary accuracy so that, for example, in the event that the harvester drives over a pothole, the position of the transfer device remains as unchanged as possible in relation to its horizontal axis of rotation. At the same time, the proportionally operating controller component may serve to damp the vibration behavior of the transfer device and therefore represents the actual state controller.

If the principle of LQI control is used, it may also be particularly advantageous if the control system comprises a state observer, which may be configured to reconstruct at least one parameter of the transfer device, which describes a state of the transfer device, without sensors and to take this at least one parameter into account as an additional input variable for determining the manipulated variable. For this purpose, the control and regulation device may use a mathematical substitute model of the transfer device so that the at least one parameter of the transfer device may be reconstructed using the mathematical substitute model. In this way, the control system (e.g., embodied in the control and regulation device) may be provided with a large number of input variables, a first part of which may be detected using at least one sensor, such as a plurality of sensors, and a second part of which may be reconstructed without sensors using the state observer.

In one or some embodiments, the mathematical substitute model may be configured to simulate an imaginary swivel joint in a central area of the transfer device. Using this mathematical substitute model, the state observer may calculate a deflection of the swivel joint and an angular velocity at the imaginary swivel joint, and thereby depict the vibrations of the transfer device that occur due to its mechanical elasticity. Such information would either be very difficult or impossible to detect by measurement, but may be reconstructed via the state observer and therefore be used as an input variable in the control system, namely for the proportionally operating controller component.

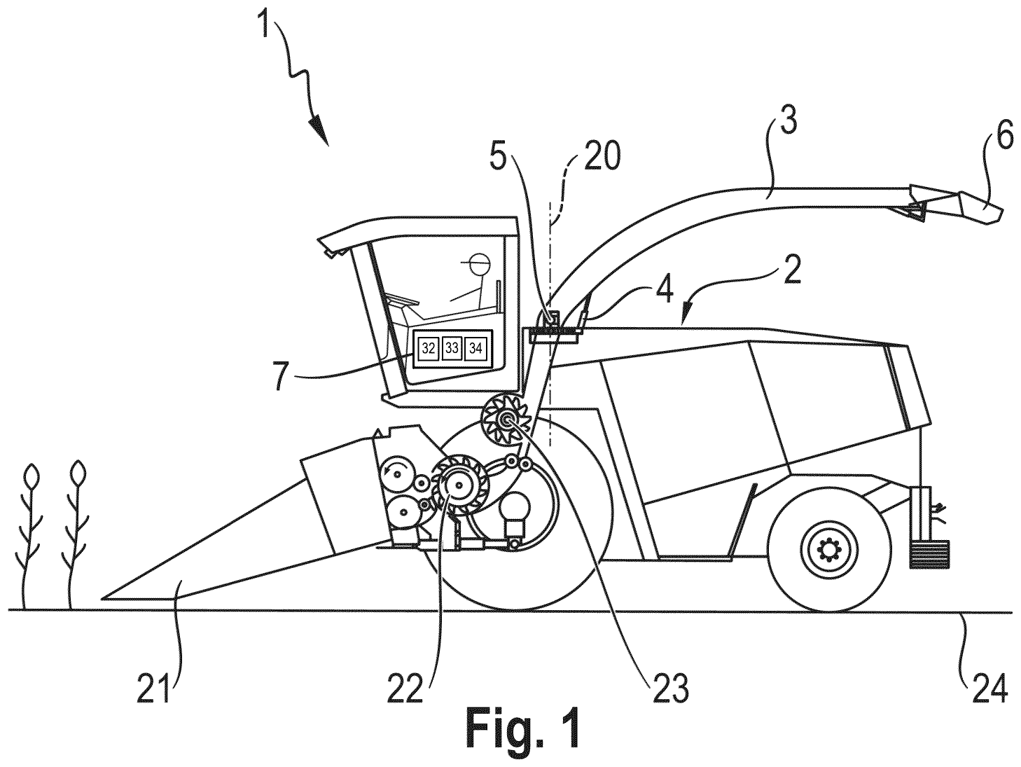

Referring to the figures, FIG. 1 illustrates a self-propelled agricultural harvester 1, which may comprise a self-propelled forage harvester. The harvester 1 comprises a machine frame 2, on which a transfer device 3 is movably mounted. Examples of harvesters with transfer devices are disclosed in US Patent Application Publication No. 20200031270 A1 or US Patent Application Publication No. 2024/0251713 A1, each of which are incorporated by reference herein in their entirety. In the depicted example, the transfer device 3 may be moved relative to the machine frame 2 both about a horizontal axis of rotation 5 and about a vertical pivot axis 20. To drive the movement or rotation of the transfer device 3 relative to the machine frame 2 about the horizontal axis of rotation 5, the harvester 1 comprises a hydraulic actuator 4, which in the depicted example is formed by a double-acting hydraulic cylinder. Other ways in which to drive the movement or rotation of the transfer device 3 relative to the machine frame 2 about the horizontal axis of rotation 5 are contemplated. At its end facing away from the machine frame 2, the transfer device 3 has an end outlet 6, at which processed harvested material emerges from the transfer device 3.

For picking up and processing harvested material, the harvester 1 in the depicted example comprises a corn bit 21 at its front end, through which plants, such as corn plants, may be cut and fed to subsequent working units for further processing. Other types of devices or attachments on the front end are contemplated. In addition, other types of plants are contemplated. Furthermore, the harvester 1 may comprise a chopping unit 22, through which the cut plants may be chopped. This may yield particle lengths of 5 mm, for example. The processed harvested material (e.g., chopped) may then be fed to an accelerating unit 23, through which the processed harvested material is accelerated and correspondingly fed to the transfer device 3 at an increased speed. As a result, the processed harvested material flows at an increased speed along the transfer device 3 and exits at its end outlet 6. In this case, the transfer device 3 is aligned relative to a transport vehicle, not shown in the figures, so that the harvested material flow discharged by the harvester 1 ends up in a loading space of the transport vehicle.

As shown particularly well from FIG. 1, the transfer device 3 is only mounted at its one end on the machine frame 2. It has a comparatively long length for transferring the harvested material to a given transport vehicle. In principle, the transfer device 3 may therefore be susceptible to vibrations, such as vibrations about the horizontal axis of rotation 5. These may occur as a result of ground excitation, for example when the harvester 1 moves on uneven ground 24. Vibrations may also occur as a result of the processed harvested material flowing along the transfer device 3.

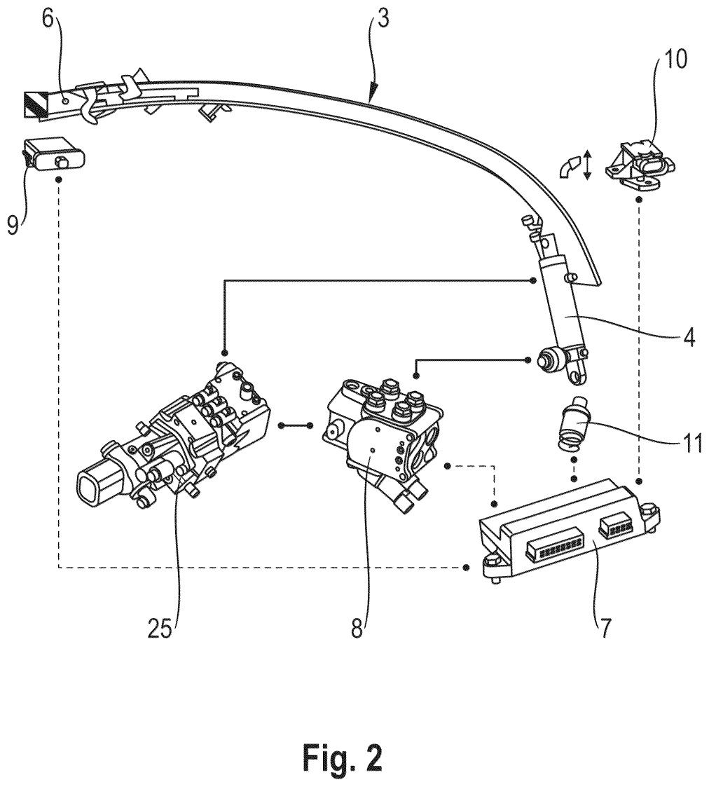

In order to dampen or reduces these vibrations of the transfer device 3, the harvester 1 has a control and regulating device 7, which is shown schematically in a driver's cab of the harvester 1 In the depicted example in FIG. 1. Alternatively, or in addition, the control and regulating device 7 may be located elsewhere, for example directly on the transfer device 3 (e.g., on the underside of the transfer device 3). The control and regulating device 7 may be configured to regulate the vibration behavior of the transfer device 3 with the aim of damping or reducing the vibrations of the transfer device 3. For this purpose, the control and regulating device 7 may be operatively connected (e.g., via communication interface 34, discussed further below) to other components of the harvester 1. These are revealed in further detail in FIG. 2.

Consequently, the harvester 1 may further comprise a proportional valve 8, which may be connected to the control and regulating device 7 in a data-transmitting manner (e.g., wired and/or wireless communication via communication interface 34 so that the control and regulating device 7 may send commands to control the proportional valve 8, as discussed further below). In the depicted example, the harvester 1 may also have a plurality of sensors 9, 10, 11, which may be suitable for detecting information relating to or indicative of parameters through which a state of the transfer device 3 may be (indirectly) described or through which a state of the transfer device 3 may be (directly) described. In the depicted example, the harvester 1 may comprise one or more sensors, such as sensor 9, which comprises a gyroscope, which may be configured to detect information relating to or indicative of a vertical acceleration of the transfer device 3. In this case, the sensor 9 may be arranged or positioned at the end outlet 6 (“discharge flap”) of the transfer device 3 so that it may be suitable for detecting information relating to the vertical acceleration of the end outlet 6. The sensor 9 may be connected to the control and regulation device 7 in a data-transmitting manner (e.g., wired and/or wirelessly) so that the information detected using the sensor 9 may be used as one or more input variables for the regulation executed by the control and regulation device 7. The vertical acceleration of the transfer device 3 at the end outlet may be a parameter that directly describes the state of the transfer device 3.

In the depicted example, a second sensor 10 comprises a position sensor, which in this case, may be formed by or comprising a potentiometer. Using the sensor 10, it may therefore be possible to detect information regarding a position of the transfer device 3 relative to the machine frame 2. In the depicted example, this position is a rotational position of the transfer device 3 about the horizontal axis of rotation 5. This rotational position may be decisive for determining the height at which the end outlet 6 of the transfer device 3 is located relative to the machine frame 2. The information detected by the second sensor 10 may also be fed to the control and regulation device 7 via a corresponding connection (e.g., wired and/or wireless connection) and may be input to the control and regulation device 7 in order for the control and regulation device 7 to perform the disclosed regulation.

In the depicted example, a third sensor 11 comprises a pressure sensor, through which information relating to or indicative of a piston-side pressure of the hydraulic actuator 4 may be detected. The sensor 11 may also be connected to the control and regulating device 7 in a data-transmitting manner (e.g., wired and/or wirelessly) so that the detected information be input to the control and regulating device 7 in order for the control and regulating device 7 to perform the disclosed regulation.

In one or some embodiments, the control and regulation device 7 is configured to determine a control variable for damping or reducing the vibrations of the transfer device 3. In one or some embodiments, the control and regulating device 7 may comprise at least one controller 32 configured to perform the determination. Further, the control and regulating device 7 may comprise at least one memory 33 and at least one communication interface 34. and at least one communication interface 41. The at least one controller 32 and at least one memory 43 may be in communication (e.g., wired and/or wirelessly) with one another. In one or some embodiments, the controller 32 may comprise a microprocessor, processor, PLA, or the like. Similarly, the memory 33 may comprise any type of storage device (e.g., any type of memory). Though the controller 32 and the memory 33 are depicted as separate elements, they may be part of a single machine, which includes a microprocessor (or other type of controller) and a memory. Alternatively, the controller 32 may rely on the memory 33 for all of its memory needs. Still alternatively, the controller 32 may rely on a database for some or all of its memory needs. The memory 33 may comprise a tangible computer-readable medium that include software that, when executed by the controller 32 is configured to perform any one, any combination, or all of the functionality described herein, such the disclosed regulation of the transfer device 3. Further, the communication interface 34 may be configured to communicate (e.g., wired and/or wirelessly) with one or more electronic devices, such as the proportional valve 8, the disclosed sensors, or the like.

The controller 32 and the memory 33 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the manipulated variable may be used to actuate the proportional valve 8. In other words, the control and regulating device 7 may serve to actuate (e.g., by one or more commands) the proportional valve 8 and thereby influence or affect the vibration behavior of the transfer device 3. In the depicted example, the determined control variable is a control current through which an actuator of the proportional valve 8, which is not shown separately in the figures, is energized, and the proportional valve 8 is adjusted as a result. As such, the control current may comprise an example of a command sent by the control and regulating device 7 to the proportional valve. The proportional valve 8 is fluidically connected to a hydraulic pump 25, which may supply hydraulic fluid under pressure. Using a change of the position of the proportional valve 8, a volume flow of the hydraulic fluid may be adjusted, which is fed to the hydraulic actuator 4. In this case, this adjustment may be smooth.

After all this, the control and regulating device 7 may be configured to determine a manipulated variable for actuating the proportional valve 8 based on the information provided by the sensors 9, 10, 11 and for accordingly actuating the proportional valve 8. In this way, the control and regulating device 7 may regulate the vibration behavior of the transfer device 3 with the aim of damping the vibrations of the transfer device 3.

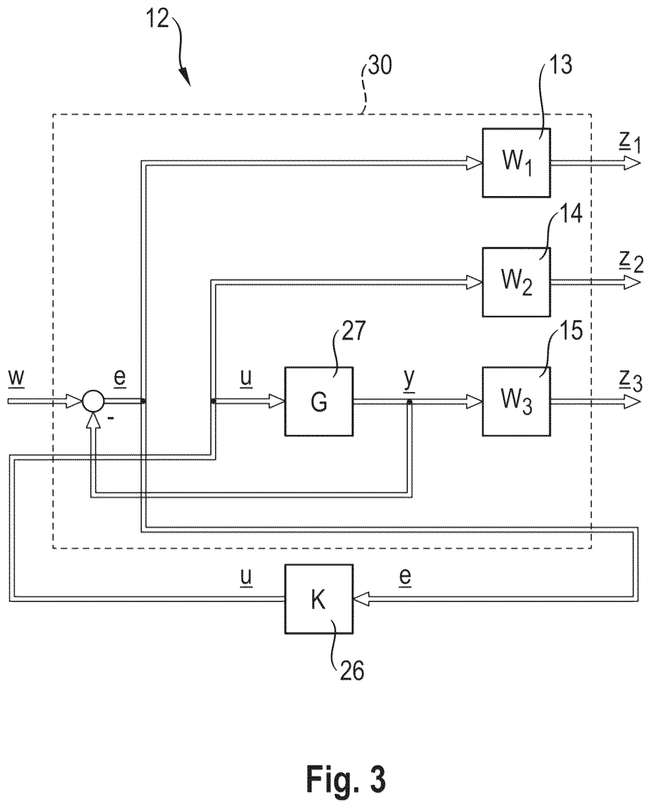

In one embodiment of the harvester 1, depicted in FIG. 3, the controller 32 implemented on the control and regulation device 7 may be designed according to the principle of an H-infinity control 12. An example of this is illustrated by the diagram shown in FIG. 3. The H-infinity control 12 comprises an H-infinity controller 26, with which the manipulated variable is determined. This may then be fed to an extended control path 30. The extended control path 30 may comprise a control path 27 and one or more weighting functions, such as a total of three weighting functions 13, 14, 15.

The first weighting function 13 may serve to weight a sensitivity of the actuation of the proportional valve 8. In this case, a dynamic with which the proportional valve 8 is actuated is weighted using the weighting function 13. The second weighting function 14 may serve to limit the manipulated variable with which the proportional valve 8 may be actuated. Finally, the third weighting function 15 may serve to weight model uncertainties of a mathematical model of the transfer device 3. These model uncertainties may be formed by deviations of the mathematical model of the transfer device 3 in comparison to the real transfer device 3. The described embodiment of the H-infinity control 12 is characterized by an extremely high robustness and a high control quality.

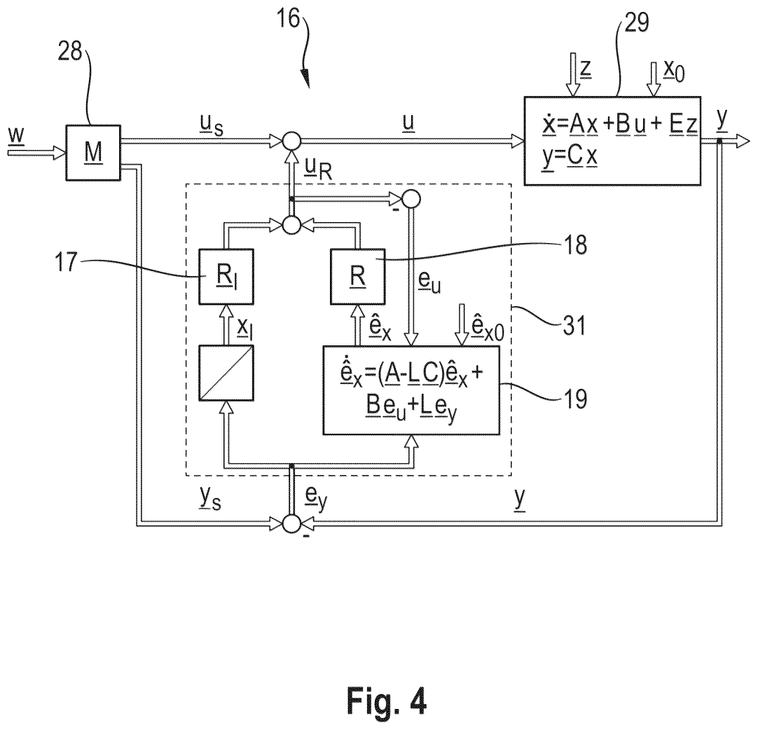

Alternatively to performing the control according to the principle of H-infinity control 12, the controller 32 on the control and regulation device 7 may be designed according to the principle of an LQI control 16. This is depicted by the diagram shown in FIG. 4. Accordingly, the LQI control 16 comprises a feedforward control 28 and a control path 29, which may use mathematical modeling of the system to be controlled. The LQI control 16 may further comprise a PI state controller 31 which in the depicted example may be equipped with a state observer 19. The PI state controller 31 may comprise an integrating controller component 17 (also referred to as an “integral component” in the art) and a proportional controller component 18 (also referred to as a “proportional component” in the art). The proportional controller component 18 may react proportionally to the current error (e.g., the difference between the setpoint and actual value), while the integrating controller component 17 considers the sum of past errors over time to ensure long-term accuracy and stability of the system. Accordingly, the LQI control 16 may be particularly robust and may have a high control quality.

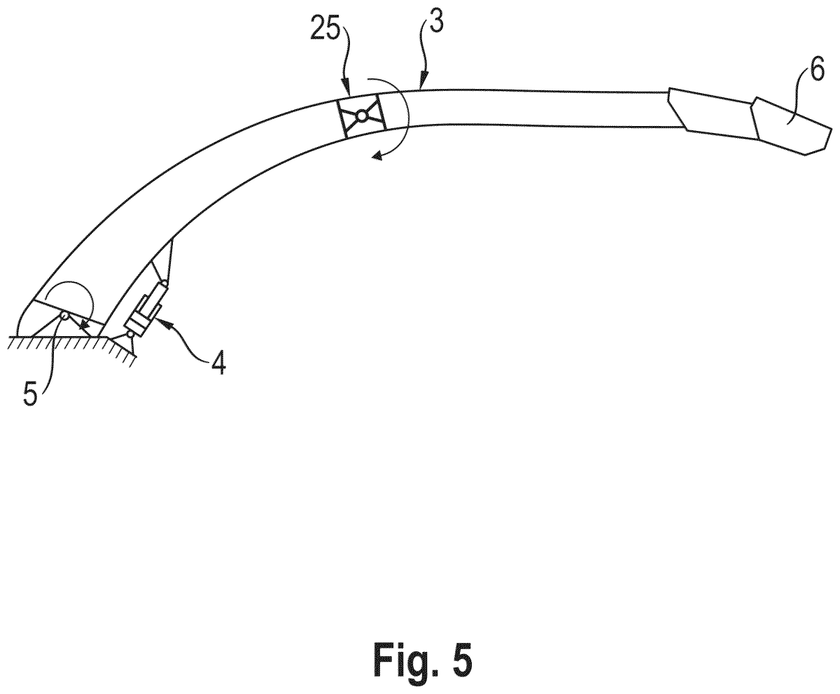

The state observer 19 may serve to reconstruct sensorless parameters that describe the state of the transfer device 3. In the depicted example, the state observer 19 may access a mathematical substitute model of the transfer device 3 which is shown by way of example in FIG. 5. In this substitute model, the transfer device 3 may be mathematically reconstructed so that parameters of the transfer device 3 may be mathematically calculated without the need in this case to arrange one or more sensors on the real transfer device 3. In the depicted example, an imaginary swivel joint 5 is simulated in a central area of the transfer device 3, at which a deflection of the transfer device 3 and an angular velocity may be determined mathematically. In this way, a large number of additional input variables may be determined using the state observer 19, which may be taken into account for the control in addition to the actually measured input variables (e.g., using the aforementioned sensors 9, 10, 11).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Harvester
2 Machine frame
3 Transfer device
4 Hydraulic actuator
Horizontal axis of rotation
6 End outlet
7 Control and regulation device
8 Proportional valve
9 Sensor (gyroscope)
Sensor (position sensor)
11 Sensor (pressure sensor)
12 H-infinity control
13 Weighting function
14 Weighting function
Weighting function
16 LQI control
17 Integrating controller component
18 Proportional controller component
19 State observer
Vertical pivot axis
21 Corn bit
22 Chopping unit
23 Accelerating unit
24 Ground
25 Imaginary swivel joint
26 H-infinity controller
27 Control path
28 Feedforward control
29 Control path
30 Extended control path
31 PI state controller
32 Processor
33 Memory
34 Communication Interface

1. A self-propelled agricultural harvester comprising:
a machine frame;
a transfer device mounted on the machine frame and configured to transfer processed harvested material to a transport vehicle;
at least one hydraulic actuator operatively connected to the transfer device, wherein the transfer device is configured to rotate relative to the machine frame about a horizontal axis of rotation via the hydraulic actuator so that a position of an end outlet of the transfer device is changed in a vertical direction relative to the machine frame;
at least one proportional valve operatively connected to the hydraulic actuator and configured to adjust a volume flow of hydraulic fluid to the hydraulic actuator; and
a control and regulation device configured to regulate vibrations of the transfer device in order to at least partly reduce the vibrations of the transfer device, wherein the control and regulation device is configured to:
determine a manipulated variable to actuate the at least one proportional valve in order to at least partly reduce the vibrations of the transfer device; and
actuate, according to the manipulated variable, the at least one proportional valve.

2. The self-propelled agricultural harvester of claim 1, further comprising at least one sensor configured to detect information relating to at least one parameter;
wherein the control and regulation device is further configured to determine, based on the information relating to at least one parameter, a state of the transfer device; and
wherein the control and regulation device is configured to determine, based on the state of the transfer device, the manipulated variable to actuate the at least one proportional valve.

3. The self-propelled agricultural harvester of claim 2, wherein the state of the transfer device comprises a position of the transfer device relative to the machine frame or acceleration of at least a part of the transfer device.

4. The self-propelled agricultural harvester of claim 3, wherein the at least one sensor is positioned on the transfer device and configured to detect information relating to vertical acceleration of the transfer device; and
wherein the control and regulation device is configured to determine, based on the vertical acceleration of the transfer device, the manipulated variable to actuate the at least one proportional valve.

5. The self-propelled agricultural harvester of claim 4, wherein the at least one sensor is positioned at an end outlet in order to detect information indicative of the vertical acceleration of the end outlet.

6. The self-propelled agricultural harvester of claim 4, wherein the at least one sensor comprises a gyroscope or an acceleration sensor.

7. The self-propelled agricultural harvester of claim 4, wherein the at least one sensor comprises a position sensor configured to generate information relating to a position of the transfer device with respect to horizontal axis of rotation of the transfer device; and
wherein the control and regulation device is configured to determine, based on the vertical acceleration of the transfer device and the horizontal axis of rotation, the manipulated variable to actuate the at least one proportional valve.

8. The self-propelled agricultural harvester of claim 4, wherein the at least one sensor comprises a pressure sensor indicative of generating information indicative of pressure; and
wherein the control and regulation device is configured to determine, based on the vertical acceleration of the transfer device and the pressure, the manipulated variable to actuate the at least one proportional valve.

9. The self-propelled agricultural harvester of claim 8, wherein the at least one hydraulic actuator comprises a double-acting, hydraulic cylinder;
wherein the information indicative of the pressure that is detected by the at least one sensor comprises information relating to a piston-side pressure of the at least one hydraulic actuator; and
wherein the control and regulating device is configured to determine, based on the vertical acceleration of the transfer device and the piston-side pressure of the at least one hydraulic actuator, the manipulated variable to actuate the at least one proportional valve.

10. The self-propelled agricultural harvester of claim 1, wherein the control and regulating device is configured to input:
information, from a sensor, indicative of vertical acceleration of the transfer device;
information, from a position sensor, indicative of position of the transfer device relative to its horizontal axis of rotation; and
information, from a pressure sensor, indicative of piston-side pressure of the at least one hydraulic actuator; and
wherein the control and regulating device is configured to determine the manipulated variable based on each of the information indicative of the vertical acceleration of the transfer device, the information indicative of the position of the transfer device relative to its horizontal axis of rotation, and the information indicative of the piston-side pressure of the at least one hydraulic actuator.

11. The self-propelled agricultural harvester of claim 10, wherein the control and regulating device is configured to determine the manipulated variable for actuating the at least one proportional valve and therefore to actuate the at least one proportional valve in such a way that pressure peaks of the at least one hydraulic actuator and acceleration peaks of the transfer device are at least partly compensated.

12. The self-propelled agricultural harvester of claim 1, wherein the control and regulating device is configured to perform regulation of the vibrations of the transfer device according to an H-infinity control.

13. The self-propelled agricultural harvester of claim 12, wherein the control and regulating device is configured to perform the regulation of the vibrations of the transfer device such that a sensitivity of the at least one proportional valve is weighted using at least one weighting function used in a context of the H-infinity control; and
wherein a dynamic with which the at least one proportional valve is actuated is weighted using the at least one weighting function.

14. The self-propelled agricultural harvester of claim 12, wherein the control and regulating device is configured to generate the manipulated variable, with which the at least one proportional valve is actuated, as being limited using at least one weighting function used in a context of the H-infinity control.

15. The self-propelled agricultural harvester of claim 12, wherein the manipulated variable comprises a control current.

16. The self-propelled agricultural harvester of claim 12, wherein the control and regulating device is configured to model uncertainties of a mathematical model of the transfer device as being weighted using at least one weighting function used in a context of the H-infinity control; and
wherein the model uncertainties are formed by deviations of the mathematical model of the transfer device from a real transfer device.

17. The self-propelled agricultural harvester of claim 1, wherein the control and regulating device is configured to perform regulation of the vibrations of the transfer device according to LQI control.

18. The self-propelled agricultural harvester of claim 17, wherein the control and regulating device comprises an integrating controller component and a proportional controller component; and
wherein the control and regulating device is configured to jointly use both the integrating controller component and the proportional controller component to determine the manipulated variable.

19. The self-propelled agricultural harvester of claim 17, wherein the control and regulating device comprises a state observer, which is configured to reconstruct at least one parameter that describes a state of the transfer device without a sensor using a mathematical substitute model; and
wherein the control and regulating device is configured to determine, based on the at least one parameter that is reconstructed, the manipulated variable.

20. The self-propelled agricultural harvester of claim 19, wherein the control and regulating device is configured to access the mathematical substitute model of the transfer device so that the state observer is configured to use the mathematical substitute model for reconstruction of the at least one parameter.
